(19) United States
(12) Patent Application Publication
(10) Pub. No.: US 2009/0032178 A1
(43) Pub. Date: Feb. 5, 2009

(54) Multi-layered ceramic tube for fuel containment barrier and other applications in nuclear and fossil power plants

(75) Inventor: Herbert Feinroth, Silver Spring, MD (US)

Correspondence Address: WILLIAM J. MASON;MACCORD MASON PLLC, POST OFFICE BOX 1489, WRIGHTSVILLE BEACH, NC, 28480, US

(73) Assignee: Gamma Engineering Corp.

(21) Appl. No.: 12/229,299

(22) Filed: Aug. 21, 2008

Related U.S. Application Data
(62) Division of application No. 11/144,786, filed on Jun. 6, 2005.
(60) Provisional application No. 60/577,209, filed on Jun. 7, 2004.

(51) Int. Cl. B29C 53/58; B05D 7/22

(52) U.S. Cl. 156/143; 427/237

(57) ABSTRACT

A multi-layered ceramic tube having an inner layer of high purity beta phase stoichiometric silicon carbide, a central composite layer of continuous beta phase stoichiometric silicon carbide fibers, and an outer layer of fine-grained silicon carbide. The ceramic tube is particularly suited for use as cladding for a fuel rod used in a power plant or reactor. The ceramic tube has a desirable combination of high initial crack resistance, stiffness, ultimate strength, and impact and thermal shock resistance.

### CROSS-REFERENCE TO RELATED INVENTIONS

This application claims the benefit under 35 U.S.C. Section 119(e) to U.S. Provisional Application Ser. No. 60/577,209, filed Jun. 7, 2004, which is herein incorporated by reference in its entirety.

### STATEMENT REGARDING FEDERALLY SPONSORED RESEARCH

The technology described in this application was developed, in part, under a Small Business Innovative Research Grant from the US Department of Energy—Grant # DE-FG02-OER83194.

### BACKGROUND

This invention relates to a device used to contain fissile fuel within nuclear power reactors. In many of today's nuclear reactors, the fuel is contained within sealed metal tubes, commonly called “fuel cladding”, which are generally made of an alloy of zirconium or a steel alloy. The fuel cladding is designed to assure that all radioactive gases and solid fission products are retained within the tube and are not released to the coolant during normal operation of the reactor or during conceivable accidents. Failure of the fuel cladding can lead to the subsequent release of heat, hydrogen, and ultimately, fission products, to the coolant.

Problems with conventional fuel cladding are known in the art. For example, metal cladding is relatively soft, and tends to wear and fret when contacted by debris that sometimes enters a coolant system and contacts the fuel. Such wear and fretting can sometimes lead to breach of the metal containment boundary, and subsequent release of fission products into the coolant. Moreover, metal cladding reacts exothermically with hot water above 2000 degrees F. (1093 degrees Celsius), thus adding additional heat to fission product decay heat that is generated by the nuclear fuel. This additional heat from the cladding can exacerbate the severity and duration of an accident, as occurred at Three Mile Island.

Many metals may also lose strength when exposed to the high temperatures that occur during accidents. For example, during a design basis loss of coolant accident, temperatures in a civilian nuclear power plant can reach as high as 2200 F (1204 degrees Celsius), and these high temperatures cause metals such as zirconium-based alloys to lose most of their strength and to expand like a balloon as a result of internal fission gas pressure. This expansion tends to block coolant flow during the emergency cooling phase of the accident. Similarly, a loss of flow accident that leads to film boiling on the surface of the fuel element creates a short duration increase in metal surface temperature and unacceptable strength loss and potential failure of the fuel element. Zirconium alloy cladding tends to oxidize and become embrittled after long exposure to coolant, and this leads to premature failure during typical reactivity insertion accidents, where the fuel pellet heats up faster than the cladding leading to internal mechanical loading and failure of the embrittled metal cladding.

To avoid the serious consequences that can occur during accidents, all metal clad fuels must be operated at substantial Departure from Nucleate Boiling (DNB) margin to prevent film boiling during loss of flow accidents. This operating restriction limits the average core heat flux, and hence, the maximum allowable heat rating of the nuclear reactor. Further, to avoid oxidation and embrittlement of zirconium alloy cladding, current Federal regulatory practice limits the amount of exposure of such metal clad uranium fuel rods to no more than 62,000 megawatt-days per tonne (mwd/t) of uranium fuel. See NUREG/CR-6703, “Environmental Effects of Extending Fuel Burnup Above 60 GWD/MTU” (January 2001).

Attempts have been made to improve fuel claddings, in order to reduce expense and increase safety during reactor accidents. For example, in U.S. Pat. No. 5,182,077 issued to Feinroth, the inventor proposed replacement of metal alloys in the fuel cladding with a continuous fiber ceramic composite (CFCC) in order to mitigate the damage imposed on metal cladding during accidents. An exemplary proposed composite was made of continuous alumina fibers and alumina matrix. These composites overcome some of the above-described deficiencies of metal cladding, but themselves have certain deficiencies limiting their use.

For example, alumina composites can lose their strength under neutron radiation, thus limiting their ability to withstand the mechanical and thermal forces imposed during accidents. Also, the alumina composites proposed in U.S. Pat. No. 5,182,077 contain 10 to 20 percent internal porosity, as needed to assure a graceful failure mode under mechanical loading. This porosity causes the composite to be permeable to fission gases, however, thus permitting unacceptable leakage of fission gas through the cladding to the coolant. See, e.g., Gamma Engineering NERI Report 41-FR, “Continuous Fiber Ceramic Composite (CFCC) Cladding for Commercial Water Reactor Fuel” (April 2001), submitted to US Department of Energy for Grant Number DE-FG03-99SF21887.

A refinement of these alumina composites was described by H. Feinroth et al. in “Progress in Developing an Impermeable, High Temperature Ceramic Composite for Advanced Reactor Clad Application,” American Nuclear Society Proceedings—ICAPP conference (June 2002). Feinroth et al. proposed the replacement of the alumina composite described in U.S. Pat. No. 5,182,077 with a double layered silicon carbide tube, in which the inner layer served as a high density impermeable barrier to fission gases, and the outer layer served as a ceramic composite that could withstand the effects of thermal and mechanical shock at high temperatures without failure. The proposed tube, however, had several deficiencies that interfered with its reliable performance in existing commercial water reactors, or for advanced high temperature reactors that use water, gas, or liquid metal coolants.

For example, the woven fiber tows in the composite layer contained large voids that may interfere with the mechanical strength, thermal conductivity, and resistance to water logging required in fuel element cladding materials. The large voids are inherent in the fiber tow weaving technique used by Feinroth et al. Also, the sintered monolithic tube used for the inside layer contained sintering additives such as boron or alumina that interfered with the ability of the tube to sustain neutron radiation without excessive swelling and failure. Such sintering additives are essential for successful fabrication of sintered SiC tubes.

The sintered monolithic tube used by Feinroth et al. for the inside layer was “alpha” crystalline phase silicon carbide, which differs in crystal structure from the beta phase fibers used to form the composite layer. As such, the inner tube will experience a different swelling rate under neutron irradiation than the composite layer containing beta phase fibers, leading to possible de-lamination during neutron irradiation. See R. H. Jones, “Advanced Ceramic Composites for High Temperature Fission Reactors”, Pacific Northwest Laboratory Report NERI-PNNL-14162 (November 2002).

Further, the composite layer used by Feinroth et al. was made from pre-woven fabric and was not pre-stressed as may be required to transfer load from the monolith when subjected to internal pressure. As a result, the monolith was more likely to fail at lower internal pressure than it would if the composite layer were able to share the load before the monolith reached its failure stress. This is shown in FIG. 12, which compares two tubes subjected to internal pressure in a test rig at Oak Ridge National Laboratory. Identical SiC monolith tubes were used for both tubes, but in the duplex tube, the monolith was reinforced with a composite layer to form a duplex tube. The duplex tube is much stronger than the monolith alone, indicating the benefits of load sharing provided by the pre-stressed fiber winding. Woven fabric duplex tubes do not provide reinforcement and therefore would not provide this load sharing characteristic.

What is needed, therefore, is an improved fuel cladding that can be used to contain fissile fuel within nuclear power reactors, which provides improved safety and performance characteristics.

### BRIEF SUMMARY OF INVENTION

The present invention provides a multi-layered ceramic tube comprising an inner layer of monolithic silicon carbide, a central layer that is a composite of silicon carbide fibers surrounded by a silicon carbide matrix, and an outer layer of monolithic silicon carbide. In a preferred aspect of the invention, the layers all consist of stoichiometric beta phase silicon carbide crystals. In another preferred aspect of the invention, a multi-layered ceramic tube can be used as cladding for a fuel rod in a reactor or power plant, either in segments or as a full-length fuel rod, and can be grouped into fuel assemblies comprising multiple ceramic tubes. In a further preferred aspect of the invention, multi-layered ceramic tubes each having a silicon carbide spacer tab or wire as an integral part of its outer surface can be grouped into fuel assemblies. In still another preferred aspect of the invention, the multi-layered ceramic tube can be used as a heat exchanger.

Additional advantages and features of the present invention will be apparent from the following drawings, detailed description and examples which illustrate preferred embodiments of the invention.

### BRIEF DESCRIPTION OF THE DRAWINGS

FIG. 1 is a schematic cross-section of a multi-layered ceramic tube of the present invention.

FIG. 2 is a photograph of fiber pre-forms used in the manufacture of ceramic tubes of the present invention.

FIG. 3 is a photograph of a fiber pre-form with the winding portion of the fabrication process only partly completed, thereby depicting the internal nature of the pre-form structure.

FIG. 4 is a plot showing the ratio of irradiated strength of silicon carbide composites over the unirradiated strength of the same composite, as a function of the irradiation level, or displacements per atom (dpa).

FIG. 5 is a schematic perspective view of a typical Pressurized Water Reactor (PWR) fuel assembly having an array of clad fuel rods within the assembly.

FIG. 6 is a schematic illustrating the mechanical configuration of integral spacer tabs that can be used to separate and support an array of silicon carbide duplex cladding tubes.

FIG. 7 illustrates a use of the multi-layered ceramic tube of this invention as a secondary containment barrier for TRISO fuel slugs.

FIG. 8 is a plot of temperature versus strength data for various types of silicon carbide composites as compared to conventional zirconium alloys.

FIGS. 9A and 9B are photographs of ceramic tubes taken during the manufacturing process. FIG. 9A shows the first two layers of a ceramic tube of the present invention, and FIG. 9B shows prior art tubes.

FIG. 10 is a schematic illustrating the testing arrangement used to measure the strength of ceramic tubes of the present invention.

FIG. 11 is a chart depicting the results of strength measurements of ceramic tubes of the present invention.

FIG. 12 is a chart illustrating the strain response of a monolith silicon carbide tube as compared to a duplex silicon carbide tube.

FIG. 13 depicts a cross-sectional view of a conventional 15×15 fuel assembly which can be clad with either silicon carbide or zircaloy.

FIG. 14 is a graph presenting results of corrosion tests of silicon carbide coupons and tubes of the present invention.

FIG. 15 is a plot of temperature versus time data obtained during exposure of a ceramic tube of the present invention to simulated loss of coolant accident conditions.

### DETAILED DESCRIPTION OF PREFERRED EMBODIMENTS

Reference will now be made in detail to the presently preferred embodiments of the invention, which, together with the following examples, serve to explain the principles of the invention. These embodiments are described in sufficient detail to enable those skilled in the art to practice the invention, and it is to be understood that other embodiments may be utilized, and that structural, chemical, and biological changes may be made without departing from the spirit and scope of the present invention.

The present invention provides a multi-layered ceramic tube that has the capability of holding gas and liquid under pressure and without leakage, and at the same time, behaves in a ductile manner similar to metals and other ceramic composites. This ceramic tube is used instead of the traditional zirconium alloys as fuel cladding, to house and contain the uranium fuel within a nuclear reactor, and to allow efficient heat transfer from the contained uranium fuel to the external coolant. The ceramic tube may also be used as a high temperature heat exchanger tube in industrial applications. The following description presents the characteristics of this invention that allow a single ceramic tube to perform both of these functions, and presents a variety of applications in nuclear and industrial markets where such features can provide value.

### A. Structure and Fabrication

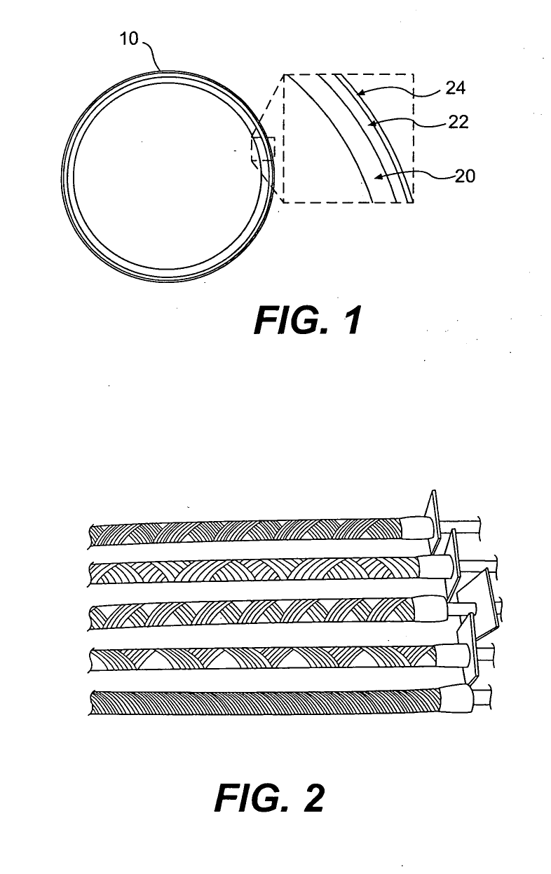

Referring now to FIG. 1, in a preferred embodiment of the invention, the ceramic tube 10 is made of three layers of silicon carbide (SiC), and is suitable for use as nuclear fuel cladding for present day nuclear reactors, and for next generation advanced nuclear reactors, as well as for other uses, as further described below in Part C of the Detailed Description. The three layers consist of an inner monolith layer 20, a central composite layer 22, and a protective outer layer 24, as shown in FIG. 1.

The inner monolith layer 20 is high purity beta phase stoichiometric silicon carbide formed by a Chemical Vapor Deposition (CVD) process. Because this layer has virtually no porosity, it serves as a fission gas containment barrier, preventing the release of radioactive fission gases during normal operation, and during accidental transients. The use of CVD beta phase SiC overcomes the deficiency of prior products such as those described in Feinroth et al., which were made of alpha phase sintered silicon carbide, contained sintering aids such as boron or alumina, and were vulnerable to unacceptable swelling during irradiation. See R. H. Jones, “Advanced Ceramic Composites for High Temperature Fission Reactors,” Pacific Northwest Laboratory Report NERI-PNNL-14102 (November 2002).

The central composite layer 22 consists of one or more layers of continuous beta phase stoichiometric silicon carbide fibers wound tightly on the inner monolithic tube, and impregnated with a silicon carbide matrix. The central composite layer 22 is made by first assembling the silicon carbide fibers into tows, winding the tows to form a pre-form, and then impregnating the pre-form with a silicon carbide matrix. The impregnation/matrix densification process converts all material in the central composite layer to beta phase SiC, which ensures uniform swelling during irradiation and avoids de-lamination, a common failure mode for other composites during irradiation.

The fiber architectures are specifically designed to resist the mechanical and thermal forces resulting from severe accidents, and the selection and control of fiber tow tension during winding promotes a more uniform distribution of matrix material between the tows and the monolith 20, and amongst the tows. The tows are commercially available, and are formed by combining 500 to 1600 high purity, beta phase, silicon carbide fibers of 8 to 14 micron diameter. The tows are wound onto the inner monolithic tube 20 in an architecture designed to provide adequate hoop and axial tensile strength and resistance to internal pressure, as shown in FIG. 2, which illustrates various fiber architectures suitable for use in the manufacture of the cladding tubes of the present invention.

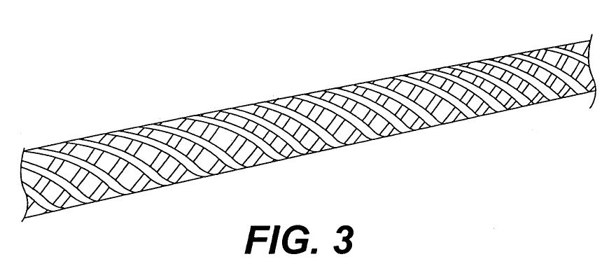

Each adjacent tow winding overlaps the previous reverse direction tow winding so as to provide resistance to delamination, and increased radial structural integrity. This is illustrated in FIG. 3, which illustrates a partially wound tubular pre-form having overlapping fiber tows. The winding angle may vary according to the desired strength and resistance, as known to those of skill in the art. Suitable mechanical strength was achieved with a winding angle alternating between +45 degrees and −45 degrees relative to the axis of the tube, and a winding angle of the layers that alternates between +52 degrees and −52 degrees optimally balances resistance to internal pressure in both the hoop and the axial directions.

The tow fibers are coated with an interface SiC coating of less than 1 micron in thickness, sometimes containing two sub-layers—an inner pyrolytic carbon sub-layer to provide the weak interface necessary for slippage during loading, and an outer SiC sub-layer to protect the carbon against an oxidizing environment. These interface coatings may be applied prior to winding, or alternatively, after winding but prior to the infiltration of the silicon carbide matrix. The presence of these interface coatings on high strength stoichiometric fibers, surrounded by a dense matrix, allows the composite layer 22 to withstand very high strains as needed to withstand accident conditions in a nuclear reactor.

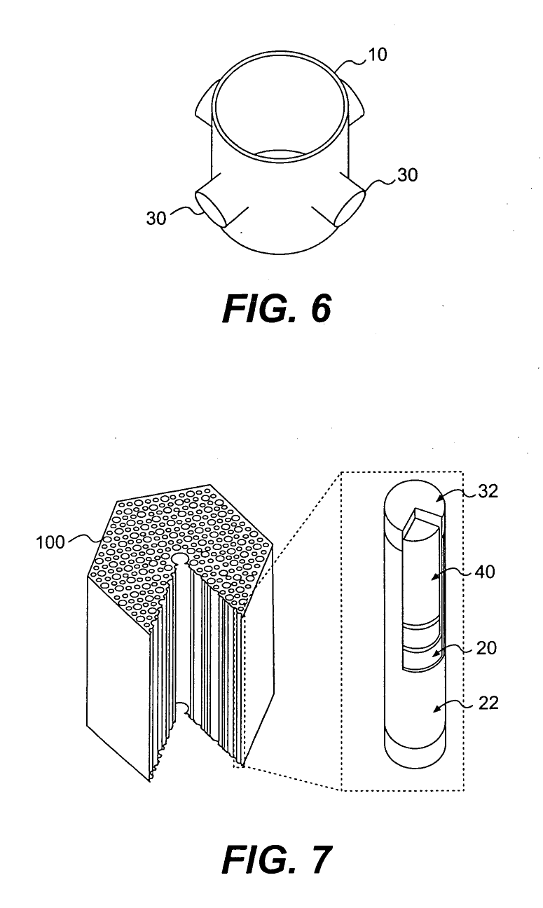

For example, Besmann et al. presents experimental evidence that carbon interface coatings of 0.17 to 0.26 microns are needed to assure fiber pullout, and a graceful failure mode, in SiC/SiC composites. See T. M. Besmann et al., “Vapor Phase Fabrication and Properties of Continuous Filament Ceramic Composites,” Science 253:1104-1109 (Sep. 6, 1991), particularly at FIG. 6. Similarly, a carbon interface layer less than about 0.5 microns thick provides an interface with the surrounding silicon carbide matrix sufficiently weak to provide for fiber pullout under applied loads, and thereby allow the cladding tube to retain its uranium fuel containment capability at hoop strains exceeding 5% of tube diameter.

This “pre-form” is then impregnated with a SiC matrix, in a multi-step process, involving matrix densification approaches such as chemical vapor infiltration (CVI), polymer infiltration and pyrolysis (PIP), or a combination of the two. The impregnation process produces a rigid pre-form with significant beta phase deposits surrounding each fiber, sometimes preceded with the use of PIP to fill the voids near the composite monolith interface. Final treatment of the densified matrix assures that all material is converted to the beta phase.

The preferred method of infiltration is the chemical vapor infiltration (CVI) process. In this process, methyltrichlorosilane (MTS) mixed with hydrogen-gas is introduced into a heated reactor containing the pre-form, typically at temperatures of 900 to 1100 degrees Celsius, resulting in the deposition of silicon carbide on the hot fiber surfaces. Pressure, temperature and dilution of the gas are controlled to maximize the total deposition, and minimize the voids remaining. Besmann et al. describes five different classes of CVI techniques that may be used for infiltration.

The CVI process may be supplemented with other infiltration methods, such as infiltration with a slurry of SiC based polymers and beta phase SiC particles, to further densify the matrix. Organic polymers are pyrolized at various times and temperatures, leaving the SiC deposit in an amorphous state. Where such a technique is used to fill in voids, a subsequent annealing is performed to convert silicon carbide to the beta phase, as needed to assure minimal and consistent growth of the matrix during irradiation. Annealing temperatures of 1500 to 1700 degrees Celsius are required to assure complete beta phase transformation, and full transformation to beta phase is needed to assure acceptable performance under neutron irradiation. See R. H. Jones, “Advanced Ceramic Composites for High Temperature Fission Reactors,” Pacific Northwest Laboratory Report NERI-PNNL-14102 (November 2002). The annealing time and temperature is chosen so as to maximize the densification and conversion to beta phase of the matrix, without causing damage to the fibers themselves.

The stiffness of the inner monolith layer 20 is much higher than the middle composite layer 22. Typically the Young's modulus of a SiC monolith will be about twice that of an SiC/SiC composite. Therefore, in order to assure that hoop stress are shared equally amongst the two load bearing layers, the composite layer 22 should be at least as thick as the monolith layer 20, and preferably thicker. A ratio of two to one, composite thickness to monolith thickness, is preferred. This is desirable to assure that no cracking occurs in the monolith during normal operation, as needed to assure retention of fission gases.

The protective outer layer 24 of the multi-layered composite 10 is an environmental protective barrier, designed to assure that the reactor coolant (water, steam, gas, or liquid metal) does not prematurely damage the composite layer 22 due to chemical attack or corrosion effects. For some applications and coolants, this outer protective layer 24 may not be required. The outer protective layer 24 is normally made of a thin (less than 5 mils) silicon carbide layer deposited via chemical vapor deposition methods onto the previously described composite layer 22. The silicon carbide used in this third layer is high purity beta phase stoichiometric silicon carbide, and it may be machined to a fine surface finish as needed for some applications in civilian nuclear reactors.

The ceramic tube 10 may be manufactured in a variety of sizes, depending on the desired application and on the available manufacturing equipment. For example, for application as fuel element cladding, a ceramic tube over 12 feet long is usually desired, with seals at the ends to withstand high pressure. Fabrication of such a long tube with sealing may be achieved by first fabricating shorter sections of the monolith layer, joining them together by proven techniques such as microwave joining, and then forming the second composite layer and third protective layer over the entire length of the tube. In this way, the required strength and toughness features of the long tube are maintained in the finished product, reducing any weakness at the joint that could cause premature failure of the finished product.

Alternatively, very long length CVD reactors may be used to manufacture the 12 foot long tubes without the need for joining. The final silicon carbide end plug is joined (by ceramic joining processes such as microwave joining or brazing) to the tubing at the fuel factory, after the fissile fuel is inserted into the tube. This joint is designed to withstand mechanical and thermal loading imposed on the fuel rod during operation and during accidents. One end of the tube may be sealed with a similar end plug during tube fabrication prior to shipment to the fuel factory.

### B. Physical and Mechanical Behavior

The multi-layered ceramic tube is a hybrid structural composite. The design and processing approaches outlined in this patent enable the multi-layered ceramic tube to possess a combination of high initial crack resistance, stiffness, and ultimate strength, excellent impact and thermal shock resistance. The multi-layered concept overcomes many of the individual limitations of monolithic ceramics and fiber reinforced ceramics. For example, the inner monolith layer is much stiffer (less elastic) than the middle composite layer, so using a central composite layer that is at least as thick, and preferably thicker, than the inner monolith layer helps share hoop stress equally amongst these two load-bearing layers. Sharing the hoop stress helps prevent cracking from occurring in the monolith during normal operation, thereby retaining fission gases.

It is also expected that the degree of bonding between the two layers will have an impact on load sharing, and the ability of the central composite layer to arrest cracks that may occur in the monolith layer during accidents. Although fission gas retention is not a requirement during design basis accidents such as Loss of Coolant Accidents, the ability of the central composite layer to arrest cracks in the monolith is of great importance during such accidents because it assures maintenance of a coolable geometry, which is an important safety and regulatory requirement.

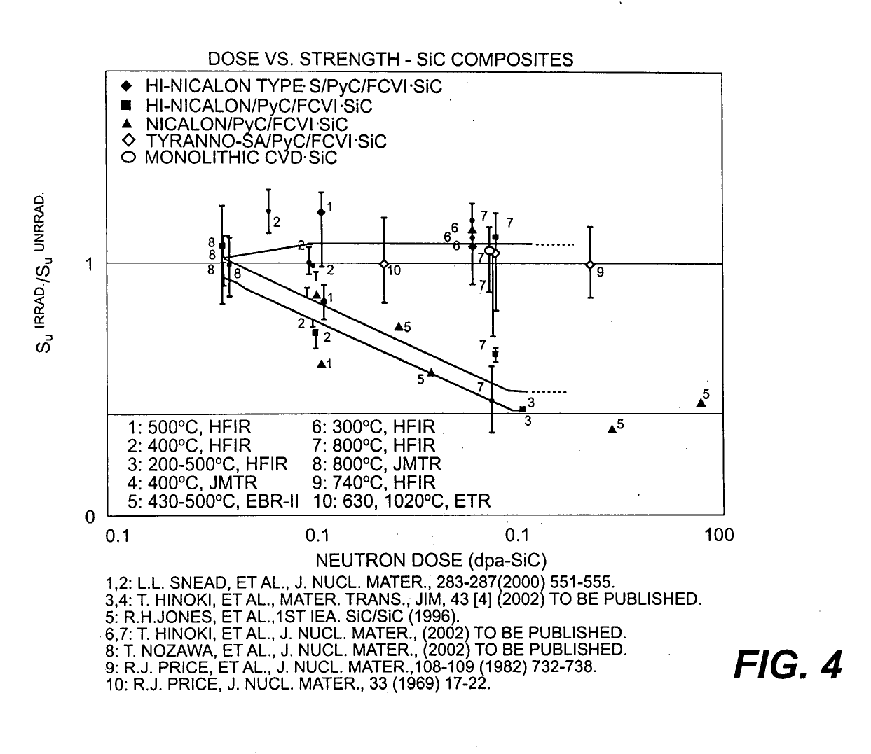

Mechanical tests were performed on samples of a duplex ceramic tube of the present invention, as described in Example 4. The duplex ceramic tubes are ceramic tubes of the present invention that have not yet had the outer protective layer fabricated; i.e., the duplex tubes have inner monolith and central composite layers as described previously. As described in Example 4, the central composite layer continues to maintain its basic structural integrity out to a total strain of 9 percent, which indicates that the ceramic tube is able to survive accidents without bursting and releasing fuel. Moreover, silicon carbide has an acceptable swelling behavior out to 100 displacements per atom (dpa) when irradiated, which is equivalent to over 30 years of commercial PWR plant operation. See R. H. Jones, “Advanced Ceramic Composites for High Temperature Fission Reactors”, Pacific Northwest Laboratory Report NERI-PNNL-14102 (November 2002). Also, when silicon carbide composites are fabricated with recently available stoichiometric fibers, they retain their strength to very high irradiation levels as demonstrated in FIG. 4.

For example, the test results, in combination with the data of FIG. 4, indicate that the ceramic tube can withstand the forces of a reactivity insertion accident out to very high dpa levels, equivalent to 100,000 megawatt days per tonne of uranium burnup, or higher. Likewise, the test results also indicate that the ceramic tube can survive a design basis reactivity accident, in which the contained uranium fuel pellet expands against the inside of the cladding causing very high strains. The ceramic tube's accident survival ability is a significant advantage over conventional zircaloy cladding, because it permits the ceramic tube to be used for longer periods of time and at higher burnups.

Conventional zircaloy cladding, when fully irradiated, is expected to fracture in a brittle manner after only 1 to 2 percent strain. After long exposure (about five years) to high energy, conventional zircaloy and metals used for fuel cladding become embrittled, which creates a safety problem during the high temperature and/or high thermal loading conditions that may occur during plausible accidents situations. To limit embrittlement and avoid bursting of the cladding, the current Nuclear Regulatory Commission (NRC) practice is to limit fuel burnup in operating water-cooled civilian nuclear reactors to 62,000 megawatt days per tonne of contained uranium (mwd/t) for zircaloy-clad uranium fuels. The analytical basis for this limitation of zircaloy-clad fuel is presented in NUREG/CR-6703, “Environmental Effects of Extending Fuel Burnup Above 60 GWD/MTU” (January 2001), and Westinghouse Report WCAP-15063-P-A, Revision 1, with Errata, “Westinghouse Improved Performance Analysis and Design Model (PAD 4.0)” (July 2000).

The multi-layered ceramic tube of the present invention, however, is expected to retain its toughness, even after very long energy extraction periods (>10 years), thus allowing a greater amount of energy extraction, improving both the economics and resource utilization and the quantity of radioactive wastes produced per unit of electricity produced. Energy extraction rates exceeding 100,000 mwd/t may be practical with this new invention. Such high rates of energy extraction will substantially reduce the quantity of spent fuel per kilowatt-hour of energy produced, thus reducing the burden on the National Geologic repository for spent fuel.

Tests performed as described in Example 7 indicate that the silicon carbide composites used in the ceramic tube of the present invention retain their strength and do not experience significant corrosion or weight change when exposed to temperatures exceeding 1200 degrees Celsius. These test results indicate that the ceramic tube of the present invention is capable of surviving a design basis loss of coolant accident even if temperatures exceed 1200 degrees Celsius for periods exceeding 15 minutes, without releasing fragments of contained uranium to the coolant, and without loss of the ceramic tube's structural integrity. It is expected that future testing will demonstrate even higher temperature tolerance for longer times than demonstrated in these preliminary tests.

The ceramic tube's enhanced strength when exposed to high temperatures permits the allowable temperature of the clad surface to be increased to 900 degrees Fahrenheit (482 degrees Celsius) and higher for short durations, such as occurs during loss of flow accidents, without loss of mechanical strength. In other words, departure from nucleate boiling (DNB), can be permitted, something that is currently prohibited by NRC regulatory practice for metallic cladding. See NUREG/CR-6703, “Environmental Effects of Extending Fuel Burnup Above 60 GWD/MTU” (January 2001), and Westinghouse Report WCAP-15063-P-A, Revision 1, with Errata, “Westinghouse Improved Performance Analysis and Design Model (PAD 4.0)” (July 2000). Permitting DNB will allow higher heat fluxes during normal operation, which will, in turn, allow a power up-rating of licensed civilian reactors beyond what is now possible with metallic cladding. This in turn will allow nuclear plant owners to generate electricity at a higher rate from existing nuclear power plants.

The ceramic tube's retention of strength at high temperatures also permits it to perform both the gas retention functions and the strength with ductile behavior functions required of fuel cladding, at much higher temperatures than typical metal tubes. See test results in Example 1. This strength also permits the ceramic tubes of the present invention, when used as fuel cladding, to be operated for much longer times, and with much greater energy production, before requiring replacement, as compared to current zircaloy clad fuels.

Another advantage of the ceramic tube is that silicon carbide is a very hard material, and it will not wear away due to contact with hard debris or grid spring materials. Currently, there is a small, albeit acceptable, failure rate in conventional zircaloy clad fuel assemblies, due primarily to cladding failure from debris or grid fretting. The root cause of such failure is the relatively soft nature of the metallic cladding. The hardness of the ceramic tube is an advantages because failure rates will be substantially lower, leading to reduced plant outages, and lower fuel replacement costs. An additional benefit will be that after removal from the reactor for storage, shipment and ultimate disposal, the cladding will have greater remaining strength and durability, as compared to the current zircaloy cladding. This will provide safety benefits during the extended storage and disposal of spent nuclear fuel.

### C. Applications of the Multi-Layered Ceramic Tube

### Pressurized Water Reactor (PWR) Use

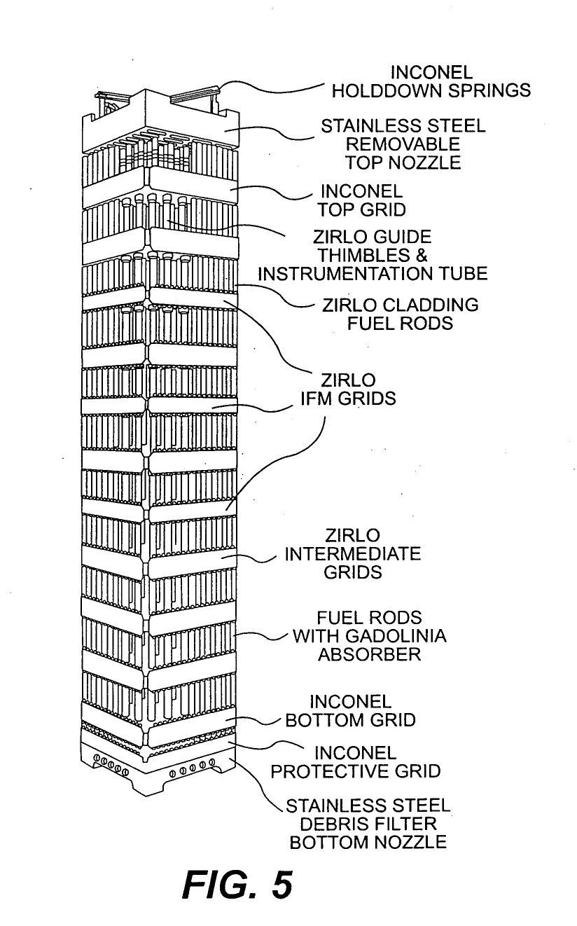

FIG. 5 depicts a typical Pressurized Water Reactor (PWR) fuel assembly having an array of clad fuel rods within the assembly. There are about 67 PWRs currently in operation in the United States, with some having the 15×15 array shown in FIG. 5, and others having larger arrays using smaller diameter fuel rods. The individual fuel rods may be clad with conventional zirconium alloy, or the multi-layered ceramic tube of the present invention.

Conventional zirconium alloy clad tubes used in 15×15 fuel rod arrays have an outer diameter of about 0.422 inches, and so the outer diameter of the ceramic tube of the present invention should be about 0.422 if designed for replacement of a conventional fuel rod cladding tube. Having the same outer diameter permits the ceramic tube of the present invention to be a direct replacement for a conventional tube in a 15×15 fuel rod array typically used in a PWR fuel assembly. A ceramic tube having an outer diameter of about 0.422 inches will have a monolith inner layer about 0.010 inches thick, a central composite layer about 0.013 inches thick, and a protective outer layer about 0.002 inches thick.

### Boiling Water Reactor Use

A second type of reactor in use today is the boiling water reactor (BWR). There are 35 such reactors in commercial use in the United States. Here again there are several different fuel element designs in use. An example of one that is prevalent is the 9×9 design. The conventional zircaloy cladding in current 9×9 BWR designs has 0.424 inch outside diameter with a 0.030 inch wall thickness. The replacement ceramic cladding would have roughly the same outside diameter and wall thickness, with an inner monolith layer of about 0.012 inches, a central composite layer of 0.014 inches, and an outer layer of about 0.004 inches. This would provide a direct replacement for the zircaloy clad 9×9 BWR design.

### Fuel Rod Support System Using Spacer Tabs

A unique design feature can be incorporated into the individual fuel rod that will allow stable and long term support of an “array” of ceramic clad fuel rods (designated a “fuel assembly”) having external dimensions that will allow direct replacement of an existing metal clad fuel assembly in current commercial reactors. This design feature is an integral spacer tab, or spacer wire, located at several axial and radial locations along the clad tube, that maintains the spacing between fuel rods required for heat extraction by the flowing coolant. Because silicon carbide is a very hard material, the spacer tab or wire minimizes the possibility of fretting failure that would occur if a traditional metal grid with springs were used for supporting the fuel rods. Integral spacer tabs made from metal have been used as fuel rod support features in some existing reactors, for example in the CANDU commercial reactors used in Canada, and in the Fast Flux Test Facility reactor built and operated at the Department of Energy's Hanford, Washington, facility. FIG. 6 depicts a typical integral spacer tab array 30 on the outside surface of the silicon carbide duplex tube 10 claimed in this invention.

A third option for supporting the silicon carbide-clad fuel elements in a fuel assembly array is to utilize the same type of metallic grid currently used to support zircaloy clad fuel rods. An example of such a grid is shown in FIG. 5. Because the silicon carbide clad fuel rod will be considerable stiffer than the current zircaloy clad fuel rods, the distance between support grids can be increased while avoiding flow induced vibration, thereby reducing the number of grids required for each fuel assembly. This would lead to lower cost, reduced parasitic neutron absorption, and reduced resistance to flow, all allowing improved fuel assembly performance.

### Segmented Rods, and Relocation During Refueling

As discussed previously in Part A of the Detailed Description, the ceramic tubes of the present invention may be manufactured in pieces that are brazed or otherwise joined together, or may be manufactured as a single 12 foot unit. An alternative method for fabricating 12 foot long fuel rods is to utilize several shorter fuel rod segments that can be joined together with a mechanical attachment, such as a threaded connection, either in the field or at the fuel factory.

Although this technique has sometimes been used in commercial water reactors for test fuel elements, to be sent for laboratory examination, it has not been used in commercial fuel. The reason is that the additional end plugs and axial fission gas plenums would lead to unacceptable axial peaking factors, to significant loss of heated surface within the reactor core, and to a reduction of fuel volume that would lead to unacceptable increases in uranium enrichment levels.

If silicon carbide cladding is substituted for zircaloy cladding in future water reactors, these reasons would be mitigated, thus permitting the use of segmented rods. For example, because silicon carbide cladding is much stiffer than zircaloy, and does not creep down on to the fuel pellet as a result of external pressure, the inherent free gas volume in a silicon carbide clad fuel element may be sufficient to contain the fission gas without an axial plenum. The water reactor fuel elements used in today's CANDU fuel are in essence segmented rods, do not contain axial plenums, and have acceptable axial peaking factors. Based on this analysis, the use of silicon carbide cladding as proposed herein may permit the use of segmented fuel rods in commercial PWRs and BWRs thus providing the possible advantages of relocating each fuel segment during refueling, thereby allowing substantial reductions in peak to average heat ratings, and peak to average burnups.

The use of segmented rods would also allow the reuse of the individual segmented rods directly in a CANDU reactor, the so-called DUPIC concept, without ever requiring the decladding and dry recycle of the LWR fuel rods required by previous DUPIC concepts. Current DUPIC economics are unfavorable primarily because of the need to de-clad and refabricate the spent nuclear uranium fuel. See H. Choi et al., “Economic Analysis of Direct Use of Spent Pressurized Water Reactor Fuel in CANDU Reactors,” Nuclear Technology 134(2) (May 2001). Segmented silicon carbide clad PWR reactor fuel would eliminate this very costly process, and make the DUPIC cycle commercially viable.

### Advanced Supercritical Water Reactor Use

The United States and other countries are designing advanced nuclear reactors, some of which will be cooled with supercritical water. Many coal fired power plants already operate with supercritical water. The design of advanced supercritical water reactors is one of six advanced concepts being studied by the Generation IV International Forum. The ceramic tubes of the present invention are useful as fuel cladding for these reactors.

In one version of this advanced reactor, the coolant outlet temperature is 500 degrees Celsius and the plant efficiency is 44 percent, as compared to current PWRs having an outlet temperature of 300 degrees Celsius and a plant efficiency of 33 percent. Zirconium alloys cannot be used as fuel cladding at these temperatures because they lack adequate mechanical strength. Steel super alloys and oxide dispersion steels are being considered as possible alternative metal cladding, but these materials are parasitic neutron absorbers and interfere with the ability of the reactor to achieve high burnups. They may also be subject to stress corrosion cracking. Silicon carbide cladding has been studied as a fuel clad material for the US Department of Energy Supercritical Water Reactor design. Mechanical and thermal performance are equivalent to alternative cladding materials, and nuclear performance is substantially better than available alternatives.

A conceptual design of a silicon carbide fuel cladding for use in Supercritical Water Reactors has been studied by the Idaho National Laboratory. This design uses a 21×21 fuel assembly configuration, with the cladding outside diameter of 0.48 inches, and wall thickness of 0.056 inches. This design with silicon carbide cladding is capable of 32% greater burnup for the same uranium fuel loading than a design using oxide dispersion steel cladding, because it has substantially less parasitic neutron absorption properties as compared to the oxide dispersion steel. See J. W. Sterbentz, “Neutronic Evaluation of 21×21 Supercritical Water Reactor Fuel Assembly Design with Water Rods and SiC Clad/Duct Materials,” Idaho National Engineering Laboratory report INEEL/EXT-04-02096 (January 2004). Additionally, the silicon carbide design had a burnup of 41,000 mwd/t, as compared with the 31,000 mwd/t for the steel clad design.

### Application to Advanced Gas Reactors

Several Generation IV advanced reactor concepts use very high temperature gas as the coolant to extract heat and allow conversion of that heat to either electricity or to hydrogen. In some cases, these advanced reactor designs use “rod” type fuel elements similar to those used in water reactors. In such cases, for example, the Fast Gas Reactor, the ceramic tube of the present invention would allow improved performance. For example, some researchers performing physics analyses of a number of different gas fast reactor preliminary designs have concluded that “SiC [cladding] is the most attractive material neutronically. Material strength requirements might limit its use, however.” E. A. Hoffman et al., “Physics studies of Preliminary Gas Cooled Reactor Designs,” Global 2003 Nuclear Fuel Cycle Conference, ANS (November 2003). The multi-layered ceramic tube disclosed in this invention would overcome this strength limitation, and allow future designers to take advantage of the neutronic advantages offered by silicon carbide.

### Liquid Metal Cooled Reactors

Several of the advanced reactors being developed under the Generation IV International Program use liquid metal coolants, including lead and a lead-bismuth eutectic. Outlet temperatures in the 700 to 800 degrees Celsius range are being considered. The multi-layered silicon carbide fuel cladding disclosed in this invention can be used in this application with similar advantages to those discussed above for gas and water coolants. A literature review of various materials considered for cladding in lead cooled reactors concluded that silicon carbide duplex tubes, of the type disclosed in this invention, would be the best choice for cladding in reactors of this type. See R. G. Ballinger et al., “An Overview of Corrosion Issues for the Design and Operation of High Temperature Lead and Lead-Bismuth Cooled Reactor Systems,” Nuclear Technology 147(3):418-435 (November 2004).

### Secondary Barrier for TRISO Fuel Slurs in HTGRs

FIG. 7 illustrates another application for the multi-layered ceramic tube of the present invention, namely as a secondary containment barrier for TRISO fuel slugs in the prismatic High Temperature Gas Reactor (HTGR) being considered by the Department of Energy for an advanced Generation IV reactor to be constructed at the Idaho National Laboratory. HTGRs typically use specially developed fuel particles known as “TRISO” particles, which consist of a spherical kernel of enriched uranium fuel covered with a porous carbon buffer layer and a several micron thick silicon carbide coating. The carbon buffer layer accommodates swelling of the fuel kernel and facilitates void volume for gaseous fission products, while the silicon carbide coating acts as a mechanical barrier for gaseous fission products.

The TRISO fuel particles are sometimes compacted with graphite matrix into a cylinder, called a slug, which is inserted into a graphite block. However, in the case of the very high temperature gas reactors, for example those having outlet gas temperatures of 1000 degrees Celsius, the thin SiC coating on the particle may not be sufficient to guarantee fission gas retention; a secondary barrier may be required to assure safe operation and zero release of fission products.

The fuel assembly section 100 shown on the left of FIG. 7 is made of graphite blocks through which cylindrical holes are bored to provide coolant passages, and to provide an opening for fuel slugs, which are normally made of very small (less than 1 mm diameter) fuel particles coated with silicon carbide compacted into a graphite fuel slug of about 0.5 inches in diameter. The section shown on the right of FIG. 7 shows a secondary barrier surrounding the graphite fuel slug and serving as a secondary fission gas barrier, to contain any fission gases that are released from the TRISO fuel particles. The secondary barrier consists of a duplex (two layered version) ceramic tube 10 of the present invention, having an inner monolith layer 20 and a central composite layer 22, as well as silicon carbide endcaps 32, surrounding the fuel 40.

The multi-layered SiC tube disclosed in this invention offers a very reliable, minimally intrusive, secondary fission gas barrier for this application. The TRISO fuel particles are compacted into graphite matrix slugs (having a one-half inch outer diameter) as in the present HTGR design, and these slugs are then sealed into the multi-layered ceramic tubes of the present invention. These tubes are then inserted into the prismatic graphite blocks that form the basic building blocks of the High Temperature Reactor Core, as shown in FIG. 7.

### SiC Heat Exchanger

A common application of silicon carbide ceramic tubes in industrial applications is for the internal heat transfer tubes in shell and tube heat exchangers designed for high temperature applications. Sometimes such heat exchangers are used with fluids that are highly corrosive to metals at high temperatures, but which are compatible with the silicon carbide. A disadvantage of this type of heat exchanger, when made with monolithic silicon carbide tubes, is its failure behavior; monolithic silicon carbide fails in a brittle manner. An alternative to overcome this adverse behavior has been the use of silicon carbide fiber-silicon carbide matrix composite tubes, which retain the graceful failure mode of metals. These tubes, however, cannot contain gases or liquids at high pressure. Use of the ceramic tubes of the present invention, however, overcomes both of these disadvantages, and offers the opportunities to apply a silicon carbide heat exchanger in industrial uses that cannot be satisfied by either the all monolithic tubes, or the all composite tubes.

Application of the teachings of the present invention to a specific problem or environment is within the capabilities of one having ordinary skill in the art in light of the teachings contained herein. Examples of the products and processes of the present invention appear in the following examples.

### Example 1

### Strength Measurements of Silicon Carbide Ceramic

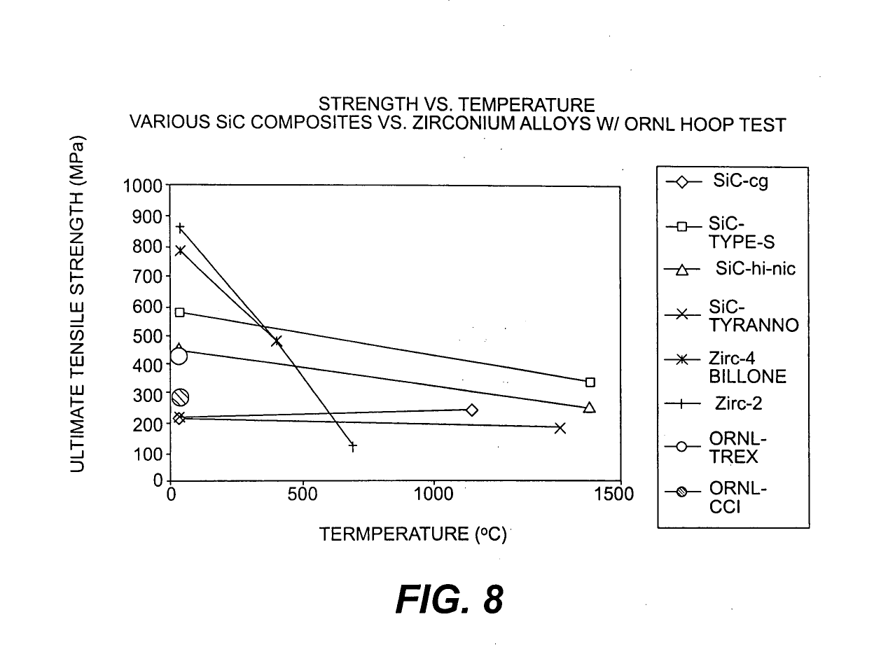

FIG. 8 is a summary of temperature versus strength data for various types of silicon carbide composites, similar to the composite layer of the present ceramic tubes, as compared to conventional zirconium alloy. Data is taken from the open literature. The abbreviations used in FIG. 8 are explained in the following table.

| Abbreviation | Meaning | Source |
|---|---|---|
| SiC - cg | SiC/SiC composite with cg-Nicalon fibers | S. J. Zinkle and L L. Snead of |
| | | ORNL |
| SiC - hi-nic | SiC/SiC composite with Hi-Nicalon fibers | H. Ichikawa of Nippon |
| | with PIP matrix and BN interphase | Carbon |
| SiC - Type-s | SiC/SiC composite with Hi-Nicalon type-S | H. Ichikawa of Nippon |
| | fibers with PIP matrix and BN interphase | Carbon |
| SiC - Tyranno | SiC/SiC composite with Tyranno-SA fibers | T. Nozawa and L. L. Snead |
| | with CVI matrix and PyC interphase | of ORNL |
| Zirc-4 Billone | Framatome low-tin Zircaloy-4 | M. C. Billone of ANL |
| Zirc-2 | Zircaloy-2 | E. Lahoda |

As illustrated in FIG. 8, zircaloy loses virtually all of its strength at temperatures of about 60° C. For this reason, operation of current water reactors is restricted such that Departure from Nucleate Boiling (DNB) is avoided, during operational transients, thus preventing failure of the cladding during such transients which could cause localized clad temperatures in excess of 800 C. As shown in FIG. 8, silicon carbide cladding retains most of its strength at temperatures of 800 C and above, thus allowing DNB to occur during operational transients without causing localized clad failure. This feature may allow substantial increase of power rating, and greater economy of current commercial nuclear reactors.

### Example 2

### Fabrication of Ceramic Tubes

Exemplary two-layered ceramic tubes of the present invention were formed by the following process. First, Chemical Vapor Deposition (CVD) processes were used to form the inner monolith layer of high purity beta phase stoichiometric silicon carbide, according to techniques known in the art. Second, commercially available fiber tows, formed of 500 to 1600 high purity, beta phase, silicon carbide fibers of 8 to 14 micron diameter, were wound tightly on the inner monolith tube, in a variety of winding patterns and using a variety of winding angles, as shown in FIGS. 2 and 3, to make “pre-forms.”

These “pre-forms” were then coated with a thin pyrolytic carbon interface layer, and then impregnated with a SiC matrix, using an isothermal pulsed flow technique of chemical vapor infiltration, described as “Type V” in T. M. Besmann et al., “Vapor Phase Fabrication and Properties of Continuous Filament Ceramic Composites,” Science 253:1104-1109 (Sep. 6, 1991). Methyltrichlorosilane (MTS) mixed with hydrogen gas was introduced into a heated reactor containing the pre-form, typically at temperatures of 900 to 1100 degrees Celsius, resulting in the deposition of silicon carbide on the hot fiber surfaces. Pressure, temperature and dilution of the gas was controlled to maximize the total deposition, and minimize the voids remaining.

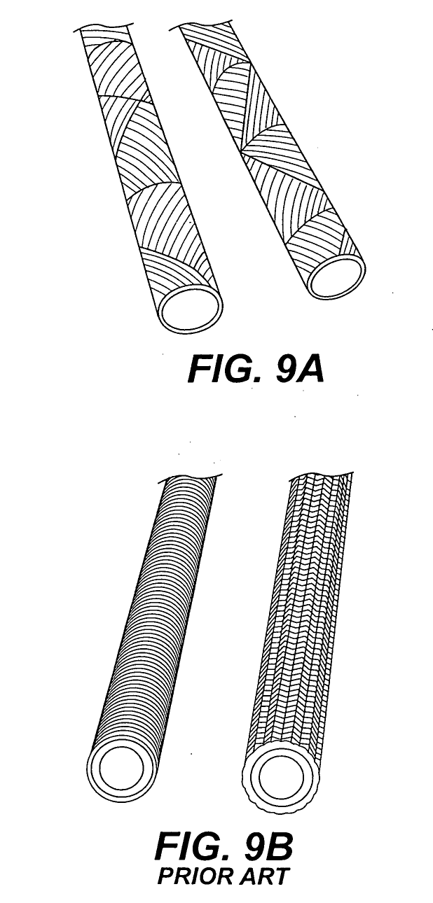

FIG. 9A illustrates tubes fabricated by this method, having a unique “crossover” fiber architecture and a matrix produced by the Chemical Vapor Infiltration process. The inner monolith layer is thin walled, about 0.030 inches. The duplex tube has a thickness of about 0.040 inches, and an outer diameter of about 0.435 inches. Normally, an outer layer of protective silicon carbide would be deposited onto these tubes to act as an environmental barrier, using CVD processes known to those of skill in the art. This deposition would normally be one of the last steps in the fabrication process.

### Example 3

### Fabrication of Prior Art Tubes

FIG. 9B illustrates two silicon carbide tubes fabricated according to the method set forth in Feinroth et al. After formation of a relatively thick monolith layer (about 0.125 inches), the tubes were covered with silicon carbide. The left tube was covered with hoop-wound silicon carbide fibers, and the right tube was covered with woven or braided silicon carbide fibers. Further details are provided in H. Feinroth et al., “Progress in Developing an Impermeable, High Temperature Ceramic Composite for Advanced Reactor Clad Application,” American Nuclear Society Proceedings—ICAPP conference (June 2002). The pre-forms were impregnated with a SiC matrix, using the method described in Example 2.

### Example 4

### Strength and Strain Testing

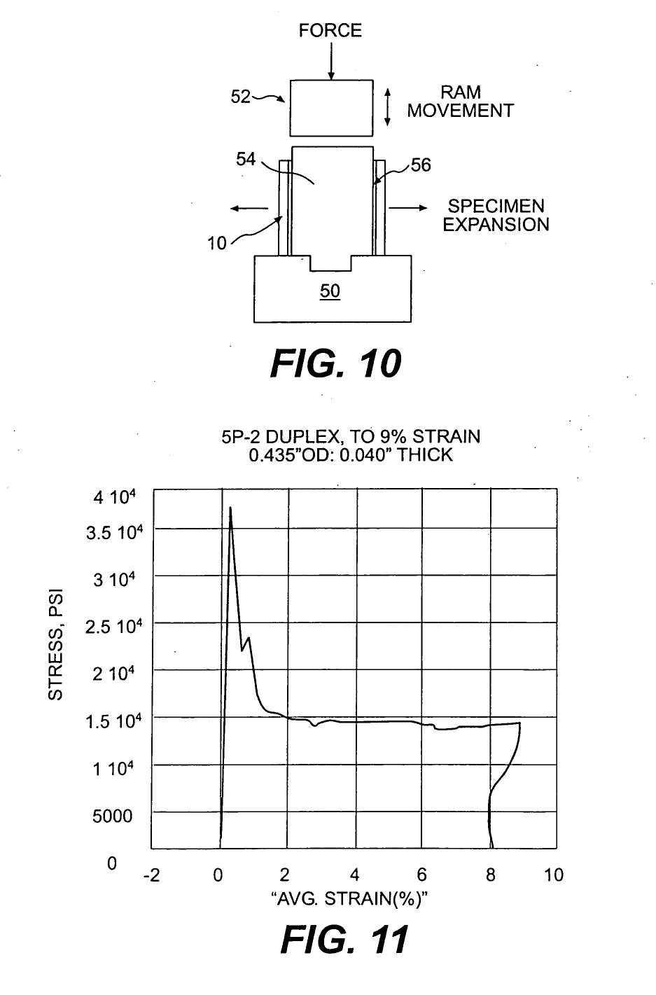

The duplex tubes fabricated in Example 2 were tested for stress-strain behavior when subjected to internal pressure at room temperature, using an apparatus depicted in FIG. 10, during January 2005 at Oak Ridge National Laboratory—High Temperature Materials Laboratory. As shown in FIG. 10, the basis apparatus consists of a support post 50 and a ram 52. The sample tube 10 is placed upright or “on-end” on the support post 50, and a polyurethane plug 54 is fitted inside the sample tube 10 so that there is initially a gap 56 between the outer diameter of the plug and the inner diameter of the sample tube. The plug 54 fits into a depression on the support post 50. Force is applied to the top of the polyurethane plug 54 using a ram 52, and the downwards force is converted into outward (hoop) force applied to the inner diameter of the sample tube 10.

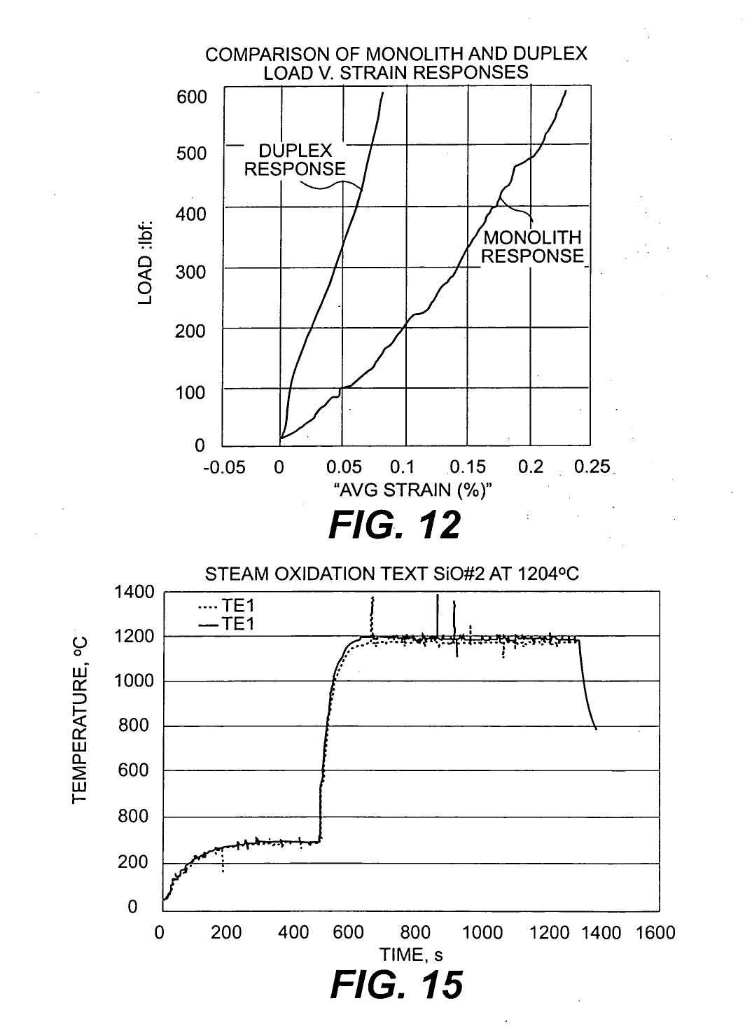

Results of these tests are presented in FIGS. 11 and 12. FIG. 11 presents the results of hoop strength measurements of typical duplex tubes of the present invention. The duplex tube tested had a monolith layer thicker than the composite layer, which therefore did not receive any reinforcement from the composite layer prior to failure. The left portion of the plotted curve (0 to 2 on the X axis) shows the rise in load versus strain while the monolith portion of the tube remains intact. This portion of the curve represents conditions that will govern during normal operation of the reactor, when the monolith inner layer contains the fission gas generated from the contained uranium fuel. As shown, the monolith fails at a stress level of about 37,000 psi. In a tube of 0.422 inch outer diameter, 30 mils total thickness, with a 15 mil monolith inner layer, this stress resistance is sufficient to hold up to 4000 psi internal pressure, which will contain the fission gases generated during extended operation of the reactor.

The right portion of the curve in FIG. 11 (2 to 9 on the X axis) illustrates that even after the monolith fails, which might occur during a severe accident, the outer composite layer hoop strength remains above 13,000 psi, out to a total hoop strain of 9 percent. The ability of the ceramic tube of the present invention to allow very high strains without the loss of basic cylindrical structure is unique to the claimed invention, and assures that the contained fuel will not be released to the coolant even in the event of a severe accident causing very high clad strains.

FIG. 12 compares the initial strain response of a duplex tube of the present invention with the initial strain response of a monolith tube, both of which were loaded via the apparatus illustrated in FIG. 10. Although the monolith tube and the monolith inner layer of the duplex tube are exactly the same, the duplex tube exhibits a much higher Young's Modulus, as a result of the reinforcement provided by the composite layer.

### Example 5

### Analysis of Parasitic Neutron Absorption and Burnup Capability

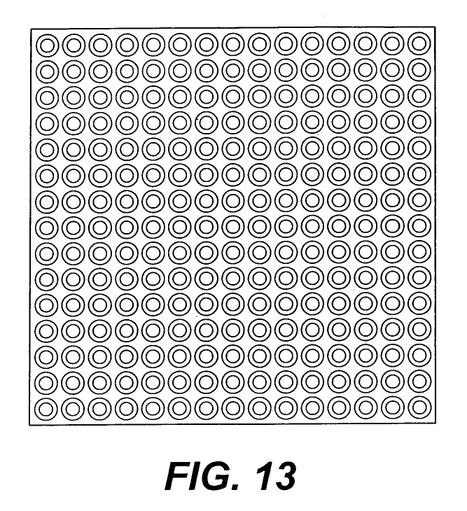

A comparative calculation of parasitic neutron absorption for a 15×15 silicon carbide clad fuel assembly of the present invention (“SiC fuel assembly”), as compared to a conventional 15×15 zircaloy clad fuel assembly is performed. Both fuel assemblies contain 225 clad fuel rods, as shown in FIG. 13, each with an active length of 366 cm and an outer diameter of 0.422 inches. The zircaloy fuel assembly cladding has an inner diameter of 0.3734 inches and a thickness of 0.0245 inches (24.5 mils). The SiC fuel assembly cladding is 0.0250 inches thick overall (25 mils), and comprises two layers, a monolith layer with an inner diameter of 0.372 inches and an outer diameter of 0.400 inches, and a composite layer with an outer diameter of 0.422 inches. The number densities of atomic species, their neutron cross-sections, and the macroscopic cross-sections for each assembly were calculated, and results are presented in the following table.

| | Zircaloy fuel assembly | | SiC fuel assembly | |
|---|---|---|---|---|
| Average number density, n | Zr | 4.035 × 10²¹ | Si | 3.890 × 10²¹ |
| (atoms/cm³) | Nb | 2.718 × 10¹⁹ | C | 3.890 × 10²¹ |
| | Sn | 3.106 × 10¹⁹ | | |
| Neutron cross section, σₐ | Zr | 0.185 | Si | 0.171 |
| (barns) | Nb | 1.150 | C | 0.0034 |
| | Sn | 0.610 | | |

| | | |
|---|---|---|
| Average macroscopic cross- | 0.0007967 | 0.0006784 |
| section. Σₐ (cm⁻¹) | | |

These results indicate that the silicon carbide clad fuel assembly will have about 15% lower parasitic neutron absorption as compared to the zircaloy clad fuel assembly, as measured by the reduced cross-section. This reduction in parasitic neutron absorption leads to a higher burnup capability and a higher, more efficient, fuel utilization, for the SiC clad assembly, assuming the same uranium enrichment for each case. For example, an increase of burnup for current LWRs from 60,000 mwd/t to 70,000 mwd/t would be possible without any increase in uranium enrichment from current levels of 5% Uranium 235 enrichment. Higher increases in burnup, to 100,000 mwd/t and higher, would be possible with higher levels of Uranium 235 enrichment.

### Example 6

### Rescission/Corrosion Testing

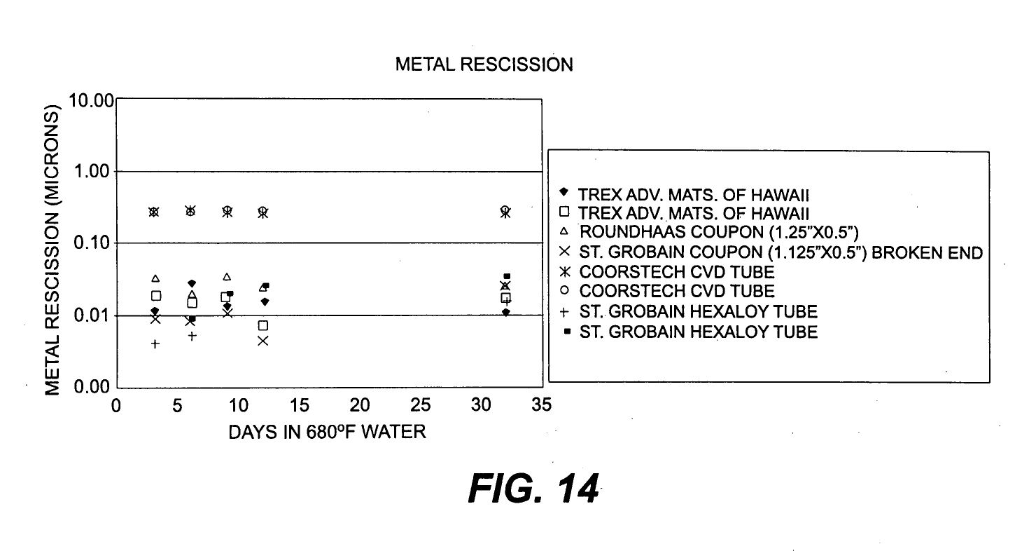

FIG. 14 is a graph presenting results of corrosion tests of silicon carbide coupons and tubes under simulated conditions representing typical BWR coolant conditions. A number of silicon carbide test coupons and tubes were exposed in a test autoclave to BWR coolant at normal operating temperatures of about 680 degrees Fahrenheit (360 degrees Celsius), along with standard advanced zirconium alloy tubes. After the test, the specimens were weighed, and the weight gain or loss was converted to rescission, or the amount of base material (load carrying) that was lost as a result of the exposure.

The data is presented as loss of material (rescission) versus exposure time. The graph also includes similar data on conventional zirconium alloys. In the case of these alloys, exposure leads to a weight gain because of oxidation of the zirconium metal to an oxide. However, the data in this graph had been converted to effective material loss, (or rescission) because that is what is important in terms of the strength of the remaining structure. FIG. 14 illustrates that the silicon carbide specimens lose structural material during exposure at a lower rate than zirconium alloys, which is another advantageous property contributing to extended duration operation in commercial reactors, and to more durable fission product containment during extended spent fuel storage and disposal periods.

All of the silicon carbide tubes demonstrated less rescission that the zirconium alloy, some by as much as a factor of 100. This increased resistance to corrosion and oxidation, at normal operating temperatures, if confirmed by more extensive, longer duration corrosion tests, will allow the duplex cladding tube to retain its durability and fission product containment function, well beyond the five years, and 62,000 mwd/t presently achievable from zirconium alloys.

### Example 7

### Simulated Loss of Coolant Accident

FIG. 15 is a temperature vs. time plot of tests performed at Argonne National Laboratory in September 2004, in which a silicon carbide tube was exposed to typical Loss of Coolant Accident Conditions in a PWR reactor, i.e., the tubes were exposed for 15 minutes at a temperature of 2200 degrees Fahrenheit (1204 degrees Celsius). This type of accident is a design basis accident for commercial nuclear reactors, and normally causes at least 17 percent oxidation of zircaloy cladding in less than 7 minutes. Argonne reported that the Silicon Carbide tube had no measurable loss of thickness during the exposure of this test. See Electronic Message from Michael Billone, Argonne National Laboratory, to Denwood Ross, Gamma Engineering, reporting results of weight measurements of “SiC steam oxidation test #2” (Nov. 2, 2004). This example illustrates that the multi-layered ceramic tube of this invention is capable of surviving a design basis loss of coolant accident exceeding 1200 degrees Celsius for periods exceeding 15 minutes, without releasing fragments of contained uranium to the coolant, and without loss of tube structural integrity.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1-20. (canceled)

21. A method of making a multi-layered ceramic tube for use in cladding of a fuel rod in a nuclear reactor comprising:
a) forming an inner layer of monolithic silicon carbide;
b) forming a central layer of silicon carbide fibers surrounded by a silicon carbide matrix over said inner layer; and
c) forming an outer layer of monolithic silicon carbide over said central layer.

22. The method of claim 21, wherein said inner layer is formed of beta phase stoichiometric silicon carbide.

23. The method of claim 21, wherein said inner layer is formed by chemical vapor deposition.

24. The method of claim 21, wherein said central layer is formed by winding at least one fiber tow of beta phase stoichiometric silicon carbide fibers around said inner layer and impregnating said fiber tow with a beta phase stoichiometric silicon carbide matrix.

25. The method of claim 21, wherein said outer layer is formed of monolithic beta phase stoichiometric silicon carbide by chemical vapor deposition.

26. The method of claim 21, wherein said inner layer, central layer and outer layer all consist of beta phase stoichiometric silicon carbide.

27. A method of making a multi-layered ceramic tube for use in cladding of a fuel rod in a nuclear reactor comprising:
a) forming an inner monolithic tube of beta phase stoichiometric silicon carbide by chemical vapor deposition;
b) winding at least one fiber tow of beta phase stoichiometric silicon carbide fibers around said inner layer and impregnating said fiber tow with a beta phase stoichiometric silicon carbide matrix to form a central layer; and
c) forming an outer layer of monolithic beta phase stoichiometric silicon carbide over said central layer by chemical vapor deposition.

28. The method of claim 27, including the step of winding said tow at an angle of from about +45 to −45 degrees relative to the axis of said tube.

29. The method of claim 27, including the step of winding multiple tows around said inner layer to form said central layer.

30. The method of claim 27, including winding each of said tows so it overlaps the previous reverse direction tow.

31. The method of claim 27, including impregnating said central layer with beta phase stoichiometric silicon carbide by chemical vapor infiltration.

32. The method of claim 27, including coating said central layer with an outer layer having a thickness of less than 5 mils.

33. The method of claim 27, wherein said inner tube is formed by joining together a plurality of tube sections, and forming said central and outer layers over said joined tube sections.

34. The method of claim 27, further including forming spacer tabs on the outer surface of said tube.

35. A method of making a multi-layered ceramic tube for use in cladding of a fuel rod in a nuclear reactor comprising:
a) forming an inner monolithic tube of beta phase stoichiometric silicon carbide by chemical vapor deposition;
b) winding a plurality of fiber tows of beta phase stoichiometric silicon carbide fibers around said inner layer so that each overlaps the previous tow in the reverse direction and impregnating said fiber tows with a beta phase stoichiometric silicon carbide matrix to form a central layer; and
c) forming an outer layer of monolithic beta phase stoichiometric silicon carbide over said central layer by chemical vapor deposition.

36. The method of claim 35, including the step of winding each tow at an angle of from about +45 to −45 degrees relative to the axis of said tube.

37. The method of claim 35, wherein said inner tube is formed by joining together a plurality of tube sections, and forming said central and outer layers over said joined tube sections.

38. The method of claim 35, further including forming spacer tabs on the outer surface of said tube.

39. The method of claim 35, wherein said tow fibers are coated with an interface SiC coating containing an inner carbon sub-layer to provide a weak interface for slippage during loading, and thereafter.

40. The method of claim 39, wherein said fibers are impregnated by chemical vapor infiltration after being coated with said interface SiC coating.
